(19) United States
(12) Patent Application Publication
(10) Pub. No.: US 2016/0312972 A1
(43) Pub. Date: Oct. 27, 2016

(54) VEHICLE LAMP

(71) Applicant: Koito Manufacturing Co., Ltd., Tokyo (JP)

(72) Inventor: Masaki Izawa, Shizuoka-shi (Shizuoka) (JP)

(21) Appl. No.: 15/095,232

(22) Filed: Apr. 11, 2016

(30) Foreign Application Priority Data
Apr. 22, 2015 (JP) 2015-087902

(51) Int. Cl. F21S 8/10

(52) U.S. Cl. CPC F21S 48/2212; F21S 48/215; F21S 48/24

(57) ABSTRACT

Disclosed is a vehicle lamp. In the vehicle lamp, a light emitting surface of a light transmitting member includes five light emitting areas and one light emitting area that are arranged to be positioned at the front side toward the outer periphery. Accordingly, the light from the light source may be emitted toward the front side without partially and extremely increasing the thickness of the light transmitting member. The five light emitting areas are divided into multiple rectangular shapes when viewed from the front side of the lamp, and each of the light emitting areas is divided into a plurality of light emitting elements. Accordingly, the mutual boundaries of the respective light emitting elements may be set in straight line shapes when viewed from the front side of the lamp so that the accuracy in diffusion-controlling the light emitted from each of the light emitting elements is improved.

### CROSS-REFERENCE TO RELATED APPLICATIONS

This application is based on and claims priority from Japanese Patent Application No. 2015-087902, filed on Apr. 22, 2015, with the Japan Patent Office, the disclosure of which is incorporated herein in its entirety by reference.

### TECHNICAL FIELD

The present disclosure relates to a vehicle lamp including a light source and a light transmitting member disposed in front of the light source.

### BACKGROUND

Conventionally, there has been known a configuration of a vehicle lamp which causes light from a light source to be emitted toward a front side by a light transmitting member disposed in front of the light source.

Japanese Patent Laid-Open Application Publication No. 2005-203111 describes such a vehicle lamp. As a configuration of a light emitting surface of the light transmitting member, the vehicle lamp includes a plurality of light emitting areas that are arranged to be positioned at the front side toward the outer periphery from the center, in a state of being divided into multiple circular shapes when viewed from the front side of the lamp.

### SUMMARY

By adopting the light transmitting member described in Japanese Patent Laid-Open Application Publication No. 2005-203111, the light from the light source may be emitted toward the front side without partially and extremely increasing the thickness of the light transmitting member, even in the case where the rear surface of the light transmitting member is formed in a rotating curved surface shape or a shape close to the rotating curved surface shape.

However, in the light transmitting member described in Japanese Patent Laid-Open Application Publication No. 2005-203111, since the light emitting surface is divided into multiple circle shapes when viewed from the front side of the lamp, it is not easy to improve the accuracy in diffusion-controlling or deflection controlling the light emitted from each of the light emitting elements even though each of the light emitting areas is divided into a plurality of light emitting elements.

The present disclosure has been made in consideration of such a situation, and an object of the present disclosure is to provide a vehicle lamp which includes a light source and a light transmitting member disposed in front of the light source, and is able to cause the light from the light source to be emitted toward the front side from the light transmitting member with excellent accuracy, without partially and extremely increasing the thickness of the light transmitting member.

The present disclosure achieves the above-described object by conceiving a configuration of a light transmitting member.

That is, a vehicle lamp according to the present disclosure includes a light source and a light transmitting member disposed in front of the light source. The light transmitting member includes a light emitting surface configured to emit light, which is incident on the light transmitting member from the light source, toward a front side. The light emitting surface includes a plurality of light emitting areas that are arranged to be positioned at the front side toward the outer periphery from the center, in a state of being divided in a shape of multiple polygons when viewed from the front side of the lamp. At least some of the plurality of light emitting areas are divided into a plurality of light emitting elements.

The type of the “light source” is not specifically limited, and, for example, a light emitting diode or a laser diode may be adopted.

The arrangement or shape of the “plurality of light emitting areas” is not specifically limited as long as the plurality of light emitting areas are arranged to be positioned at the front side toward the outer periphery from the center in the state of being divided into multiple polygonal shapes when viewed from the front side of the lamp. Further, the “plurality of light emitting areas” may not be necessarily concentrically divided and may not be necessarily formed over the entire periphery of the lamp as long as they are divided into multiple polygonal shapes when viewed from the front side of the lamp.

The light transmitting member of the vehicle lamp according to the present disclosure includes the light emitting surface configured to emit the light, which is incident on the light transmitting member from the light source, toward the front side. Since the light emitting surface includes the plurality of light emitting areas arranged to be positioned at the front side toward the outer periphery from the center, the light from the light source may be emitted toward the front side without partially and extremely increasing the thickness of the light transmitting member, even in the case where the rear surface of the light transmitting member is in the rotating curved surface shape or a similar shape thereto.

Further, the plurality of light emitting areas are divided into multiple polygonal shapes when viewed from the front side of the lamp, and at least parts of the plurality of light emitting areas are divided into the plurality of light emitting elements. Therefore, mutual boundaries of the respective light emitting elements may be set in straight line shapes when viewed from the front side of the lamp. As a result, accuracy in diffusion-controlling or deflection-controlling the light emitted from each of the light emitting elements may be improved.

According to the present disclosure as described above, in the vehicle lamp including the light source and the light transmitting member disposed in front of the light source, the light from the light source may be emitted toward the front side through the light transmitting member without partially and extremely increasing the thickness of the light transmitting member.

In the above-described configuration, when the light emitting surface is configured to be divided into multiple rectangular shapes when viewed from the front side of the lamp, the mutual boundaries of the respective light emitting elements may be set in straight line shapes that extend toward two orthogonal directions when viewed from the front side of the lamp. Accordingly, the light emitted from each of the light emitting elements may be diffusion-controlled or deflection-controlled with excellent accuracy in the two orthogonal directions (e.g., in the vertical direction and in the horizontal direction).

In the above-described configuration, when the light transmitting member is configured to include a first light control portion configured to cause the light, which is incident on the light transmitting member from the light source, to be emitted directly toward the front side, and a second light control portion configured to cause the light, which is incident on the light transmitting member from the light source, to be internally reflected and then be emitted toward the front side, the light from the light source may be effectively used depending on parts of the light transmitting member.

In the above-described configuration, when the light transmitting member is configured to be disposed in a state of being inclined in a vertical direction, each of the light emitting elements may be configured to be formed in a wedge-like shape in vertical cross section and extend horizontally so that the light from each of the light emitting elements may be easily directed toward a direction close to the front direction of the lamp, even though the light transmitting member is inclined in the vertical direction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view illustrating a vehicle lamp according to an exemplary embodiment of the present disclosure.

FIG. 2 is a front view illustrating a light transmitting member of the vehicle lamp together with a light source.

FIG. 3 is a cross-sectional view taken along the line of FIG. 2.

FIG. 4 is a view obtained when viewed in the direction indicated by the arrow IV of FIG. 3.

FIGS. 5A1 to 5B2 are views illustrating the action of the exemplary embodiment in comparison with a conventional example.

FIG. 6 is a side cross-sectional view illustrating a vehicle lamp according to a modification of the exemplary embodiment.

FIG. 7 is a front view illustrating a light transmitting member of the modification together with a light source.

FIG. 8 is a perspective view illustrating the light transmitting member of the modification together with the light source.

FIGS. 9A1 to 9B2 are views illustrating the action of the modification in comparison with a conventional example.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an exemplary embodiment of the present disclosure will be described.

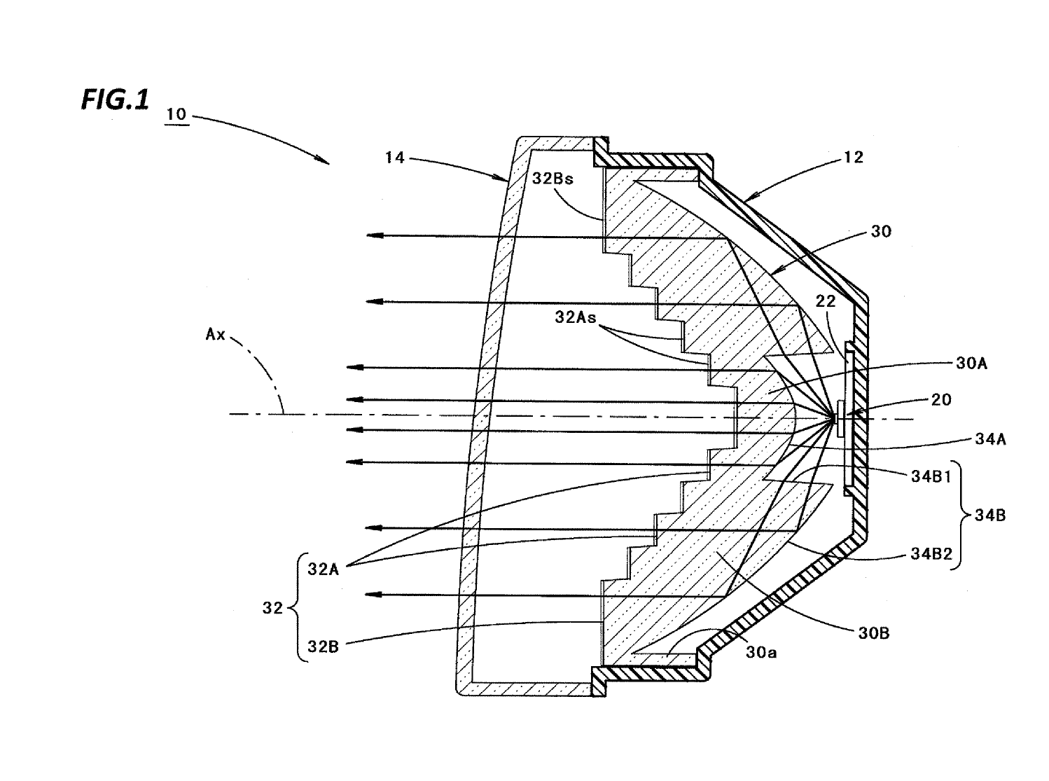

FIG. 1 is a side cross sectional view illustrating a vehicle lamp 10 according to an exemplary embodiment of the present disclosure.

As illustrated in FIG. 1, the vehicle lamp 10 according to the present exemplary embodiment is a tail lamp disposed at the rear side of the vehicle and is configured such that a light source 20 and a light transmitting member 30 are accommodated within a lamp chamber formed by a lamp body 12 and a transparent outer cover 14.

The light source 20 is a red light emitting diode and is disposed to face the front side of the lamp (the rear side of the vehicle) in a state of being mounted on a substrate 22. The substrate 22 is supported on the lamp body 12.

The light transmitting member 30 is formed of a transparent synthetic resin molded article. The light transmitting member 30 is disposed in front of the light source 20 and supported on the lamp body 12 by brackets 30a that are formed at upper and lower ends of the light transmitting member 30.

The light transmitting member 30 includes a first light control portion 30A disposed in the vicinity of an axis Ax passing through the light emitting center of the light source 20 and extending in the horizontal direction of the lamp, and an annular second light control portion 30B disposed around the first light control portion 30A. Both the first light control portion 30A and the second light control portion 30B have circular external shapes centered on the axis Ax.

The first light control portion 30A is configured to cause the light, which is incident on the first light control portion 30A from the light source 20, to be emitted directly toward the front side. Meanwhile, the second light control portion 30B is configured to cause the light, which is incident on the second light control portion 30B from the light source 20, to be internally reflected and then emitted toward the front side.

The rear surface 34A of the first light control portion 30A is formed as a rotating curved surface in a convex curved surface shape centered on the axis Ax. The rear surface 34A is adapted to make the light, which is emitted from the light emitting center of the light source 20, incident thereon toward a direction parallel with the axis Ax.

The rear surface 34B of the second light control portion 30B includes an incident surface 34B1 configured to make the light, which is emitted from the light source 20, incident thereon to be refracted toward a direction away from the axis Ax, and a reflecting surface 34B2 configured to internally reflect the light, which is incident on the incident surface 34B1, toward the front side through total reflection. At that time, the incident surface 34B1 is formed as a conical surface close to a cylindrical surface centered on the axis Ax. The reflecting surface 34B is formed as a rotating curved surface in a convex curved surface shape based on the axis Ax. Further, the reflecting surface 34B2 is adapted to reflect the light, which is incident on the incident surface 34B from the light emitting center of the light source 20, toward a direction parallel with the axis Ax.

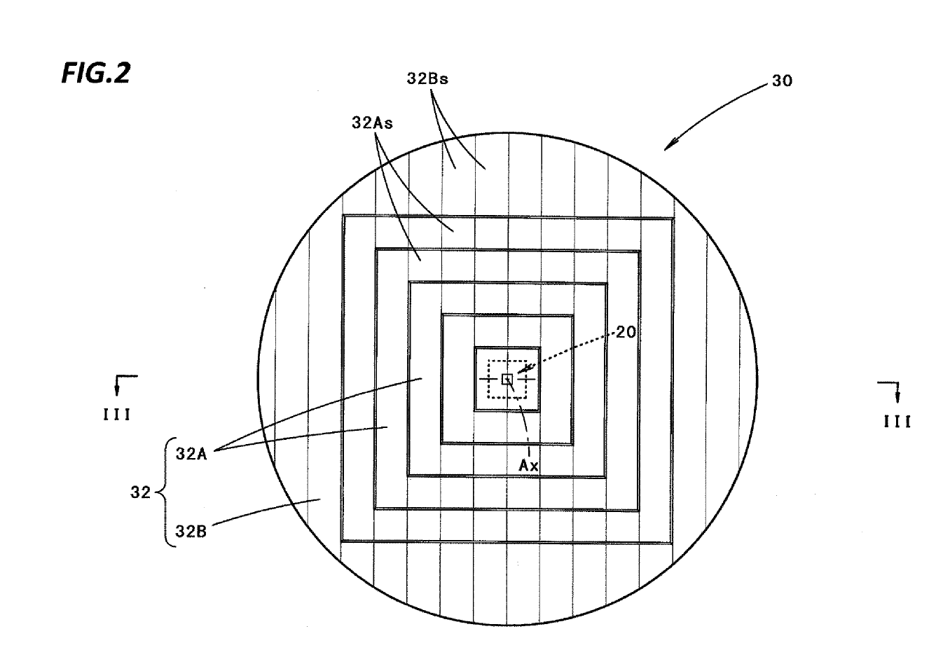

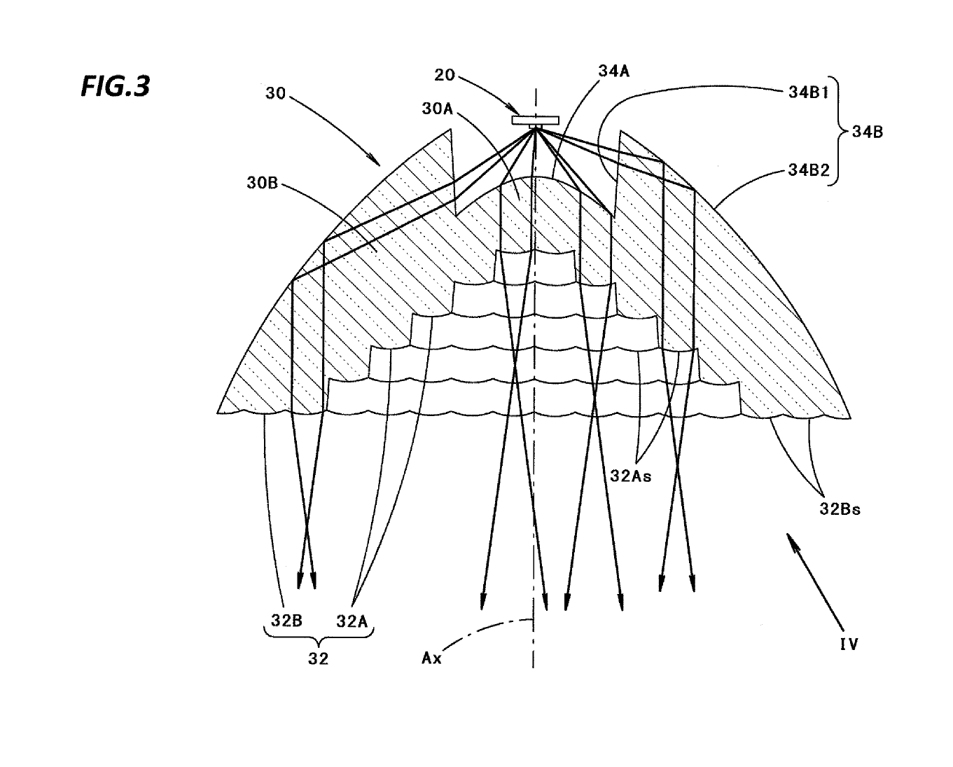

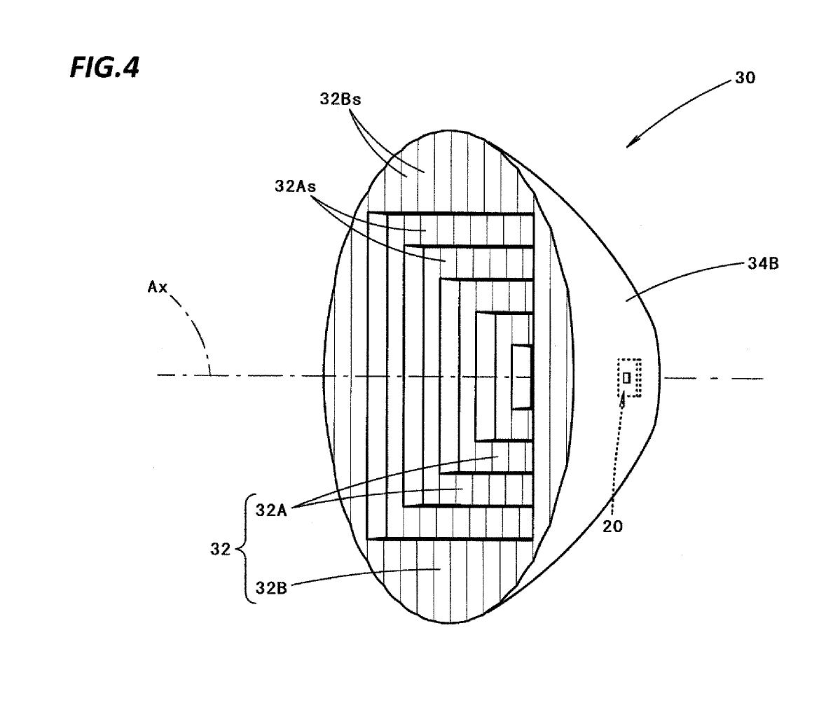

FIG. 2 is a front view illustrating the light transmitting member 30 together with the light source 20. FIG. 3 is a cross sectional view taken along the line III-III of FIG. 3. FIG. 4 is a view obtained when viewed in the direction of the arrow IV of FIG. 3. These drawings illustrate the light transmitting member 30 while omitting the brackets 30a.

As illustrated in FIGS. 2 to 4, in the light transmitting member 30, the light emitting surface 32 configured to emit the light, which is incident on the light transmitting member 30 from the light source 20, toward the front side has the circular external shape centered on the axis Ax when viewed from the front side of the lamp.

The light emitting surface 32 includes five light emitting areas 32A that are divided into multiple rectangular shapes when viewed from the front side of the lamp, and a light emitting area 32B disposed at the outer periphery of the light emitting areas 32A.

The five light emitting areas 32A are concentrically divided with the same width by square boundaries centered on the axis Ax when viewed from the front side of the lamp.

Further, the five light emitting areas 32A and the one light emitting area 32B are arranged to be positioned at the front side toward the outer periphery from the axis Ax. At that time, the five light emitting areas 32A and the one light emitting area 32B are formed in a stepwise shape at equal intervals in the front-and-rear direction.

Each of the light emitting areas 32A is divided into a plurality of light emitting elements 32As. Then, the plurality of light emitting elements 32As are divided into vertical stripe shapes at horizontally equal intervals. Each of the light emitting elements 32As has a convex-curved shape in horizontal cross section. Accordingly, each of the light emitting elements 32As is adapted to emit the light, which reaches each of the light emitting elements 32As from the light source 20, toward the front side as light diffused in the horizontal direction.

The light emitting area 32B is also divided into a plurality of light emitting elements 32Bs. The plurality of light emitting elements 32Bs are also divided into the vertical stripe shapes at horizontally equal intervals. Each of the light emitting elements 32Bs has a convex-curved shape in the horizontal cross section. Accordingly, each of the light emitting element 32Bs is also adapted to emit the light, which reaches each of the light emitting elements 32Bs from the light source 20, toward the front side as light that is diffused in the horizontal direction.

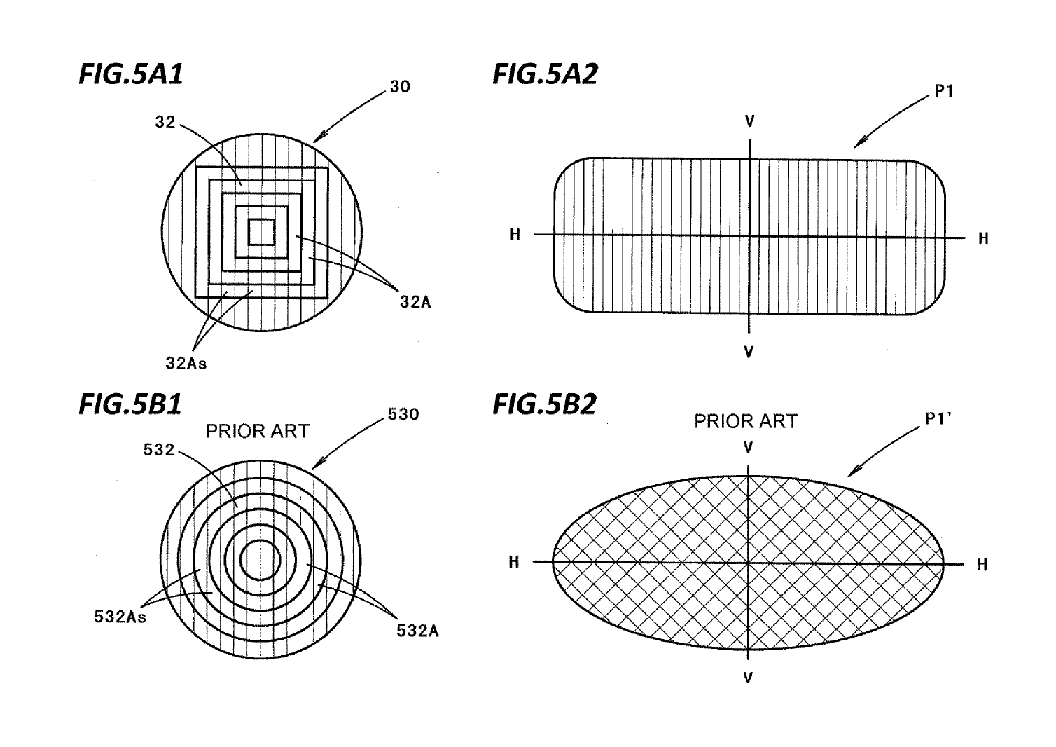

FIGS. 5A1 to 5B2 are views illustrating the action of the present exemplary embodiment in comparison of a conventional example.

FIG. 5A1 is a front view illustrating the light transmitting member 30 of the present exemplary embodiment. FIG. 5A2 is a view illustrating a light distribution pattern P1 formed by the light emitted from the light transmitting member 30.

Meanwhile, FIG. 5B1 is a front view illustrating a light transmitting member 530 according to a conventional example. FIG. 5B2 is a view illustrating a light distribution pattern P1′ formed by the light emitted from the light transmitting member 530.

The light transmitting member 530 is identical in its basic configuration to the light transmitting member 30 of the present exemplary embodiment, but is different from that of the present exemplary embodiment in that the light transmitting member 530 is configured to include a plurality of light emitting areas 532A that are divided into multiple circular shapes when viewed from the front side of the lamp. Then, each of the light emitting areas 532A is divided into a plurality of light emitting elements 532As. The boundaries of the light emitting elements 532As are formed by vertically extending straight lines and arc-shaped curved lines.

As illustrated in FIG. 5A2, the light distribution pattern P1 formed by the light emitted from the light transmitting member 30 is formed as a horizontally long light distribution pattern. At that time, the light distribution pattern P1 is formed as a light distribution pattern in which the opposite end portions in the horizontal direction have a vertical width that is substantially identical to that of the central portion in the horizontal direction, and has a substantially uniform light intensity distribution.

Such a light distribution pattern P1 is formed because the mutual boundaries of the respective light emitting elements 32As are formed by the vertically and horizontally extending straight lines when viewed from the front side of the lamp so that the light emitted from each of the light emitting elements 32As may be diffusion-controlled with excellent accuracy in the horizontal direction.

Meanwhile, as illustrated in FIG. 5B2, the light distribution pattern P1′ formed by the light emitted from the light transmitting member 530 is also formed as a horizontally long light distribution pattern. However, the light distribution pattern P1′ is formed as a light distribution pattern in which the opposite end portions in the horizontal direction have a vertical width that is significantly narrower than that of the central portion in the horizontal direction, and has a slightly non-uniform light intensity distribution.

Such a light distribution pattern P1′ is formed because the mutual boundaries of the respective light emitting elements 532As are partially formed by arc-shaped curves so that the light emitted from each of the light emitting elements 532As may not be diffusion-controlled with excellent accuracy in the horizontal direction.

Next, the acting effects of the present exemplary embodiment will be described.

The light transmitting member 30 of the vehicle lamp 10 according to the present exemplary embodiment includes the light emitting surface 32 configured to emit the light, which is incident on the light transmitting member 30 from the light source 20, toward the front side. The light emitting surface 32 includes five light emitting areas 32A and one light emitting area 32B that are arranged to be positioned at the front side toward the outer periphery from the center. Accordingly, even though the rear surface of the light transmitting member 30 is formed in the rotating curved surface shape, the light from the light source 20 may be emitted toward the front side without partially and extremely increasing the thickness of the light transmitting member 30.

Further, the five light emitting areas 32A are divided into multiple polygonal shapes when viewed from the front side of the lamp. Each of the light emitting areas 32A is divided into a plurality of light emitting elements 32As. Accordingly, the mutual boundaries of the respective light emitting elements 32As may be set in straight line shapes when viewed from the front side of the lamp. As a result, accuracy in diffusion-controlling the light emitted from each of the light emitting elements 32As may be improved.

According to the present exemplary embodiment as described above, in the vehicle lamp 10 including the light source 20 and the light transmitting member 30 disposed in front of the light source 20, the light from the light source 20 may be emitted toward the front side through the light transmitting member 30 without partially and extremely increasing the thickness of the light transmitting member 30.

Especially, in the present exemplary embodiment, the light emitting surface 32 is divided into multiple rectangular shapes when viewed from the front side of the lamp, and the mutual boundaries of the respective elements 32As are set in vertically and horizontally extending straight line shapes when viewed from the front side of the lamp. Accordingly, the light emitted from each of the light emitting elements 32As may be diffusion-controlled with excellent accuracy in the horizontal direction.

Further, in the present exemplary embodiment, the light transmitting member 30 includes the first light control portion 30A configured to cause the light, which is incident on the light transmitting member 30 from the light source 20, to be emitted directly toward the front side, and the second light control portion 30B configured to cause the light, which is incident on the light transmitting member 30 from the light source 20, to be internally reflected and then emitted toward the front side. Accordingly, the light from the light source 20 may be effectively used depending on the parts of the light transmitting member 30.

In the above-described exemplary embodiment, it has been described that the rear surface 34B of the second light control portion 30B of the light transmitting member 30 is configured as a rotating curved surface. However, the rear surface 34B may be configured as another curved surface or a plurality of plane surfaces.

In the above-described exemplary embodiment, the light emitting surface 32 of the light transmitting member 30 is divided into multiple rectangular shapes when viewed from the front side of the lamp. However, the light emitting surface 32 may be divided into other multiple polygonal shapes (e.g., diamond shapes or hexagonal shapes).

In the above-described exemplary embodiment, the descriptions have been made on the case where the vehicle lamp 10 is a tail lamp. However, regardless of a part of a vehicle where the vehicle lamp 10 is installed or a function of the vehicle lamp 10, the same acting effects as those of the above-described exemplary embodiment may be obtained by adopting the same configuration as that of the above-described exemplary embodiment.

Next, a modification of the above-described exemplary embodiment will be described.

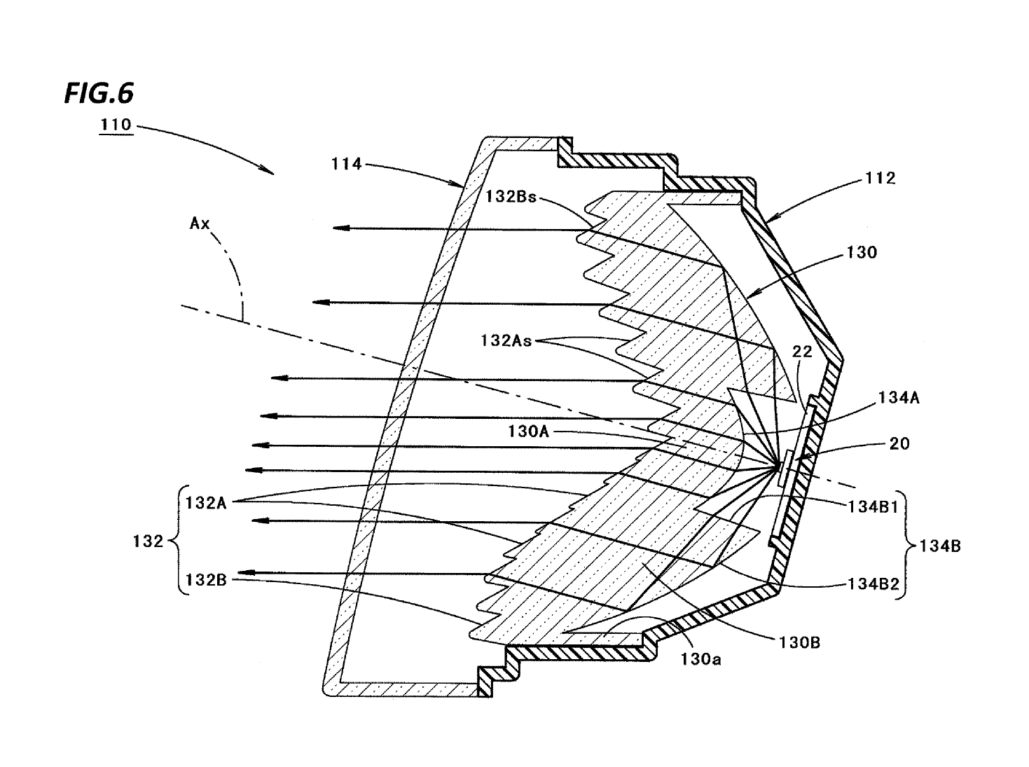

FIG. 6 is a side cross-sectional view illustrating a vehicle lamp 110 according to the present modification.

As illustrated in FIG. 6, the vehicle lamp 110 according to the present modification is also identical in its basic configuration to the vehicle lamp 10 of the above-described exemplary embodiment. However, the vehicle lamp 110 is partially different from the vehicle lamp 10 of the above-described exemplary embodiment in terms of the configuration of the light transmitting member 130 and the disposition of the light source 20. Accordingly, the lamp body 112 and the outer cover 114 of the present modification are also different in shape from those of the above-described exemplary embodiment.

In the present modification, the light transmitting member 130 and the light source 20 are arranged to face the front side in a state of being obliquely inclined upwardly, and the light transmitting member 130 is supported in the lamp body 12 by brackets 130a that are formed at upper and lower ends of the light transmitting member 30.

The light transmitting member 130 includes a first light control portion 130A disposed in the vicinity of an axis Ax passing through the light emitting center of the light source 20 and extending obliquely toward the upward front side, and an annular second light control portion 130B disposed around the first light control portion 130A. Both the first light control portion 130A and the second light control portion 130B have circular external shapes centered on the axis Ax.

The first light control portion 130A is configured to cause the light, which is incident on the first light control portion 130A from the light source 20, to be emitted directly toward the front side. Meanwhile, the second light control portion 130B is configured to cause the light, which is incident on the second light control portion 130B from the light source 20, to be internally reflected and then emitted toward the front side.

The rear surface 134A of the first light control portion 130A is configured as a rotating curved surface in a convex curved surface shape centered on the axis Ax. The rear surface 134A is adapted to make the light, which is emitted from the light emitting center of the light source 20, incident thereon toward a direction parallel with the axis Ax.

The rear surface 134B of the second light control portion 130B includes an incident surface 134B1 configured to make the light, which is emitted from the light source 20, incident thereon to be refracted in a direction away from the axis Ax, and a reflecting surface 134B2 configured to internally reflect the light, which is incident on the incident surface 134B1, toward the front side through the total reflection. Then, the incident surface 134B1 is formed as a conical surface close to a cylindrical surface centered on the axis Ax. The reflecting surface 134B2 is configured as a rotating curved surface in a convex curved surface shape centered on the axis Ax. Further, the reflecting surface 134B2 is adapted to reflect the light, which is incident on the incident surface 134B1 from the light emitting center of the light source 20, toward a direction parallel with the axis Ax.

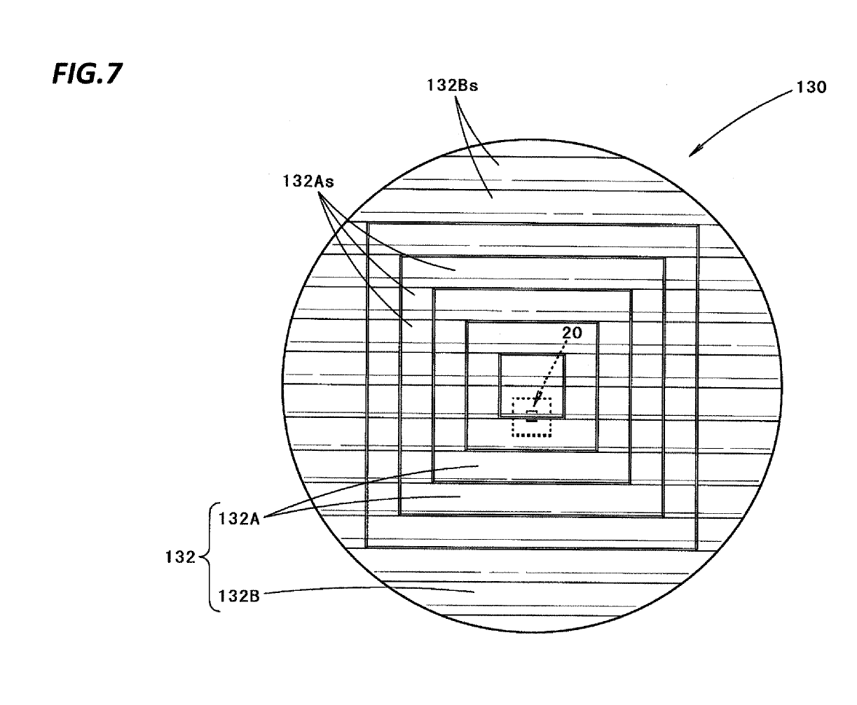

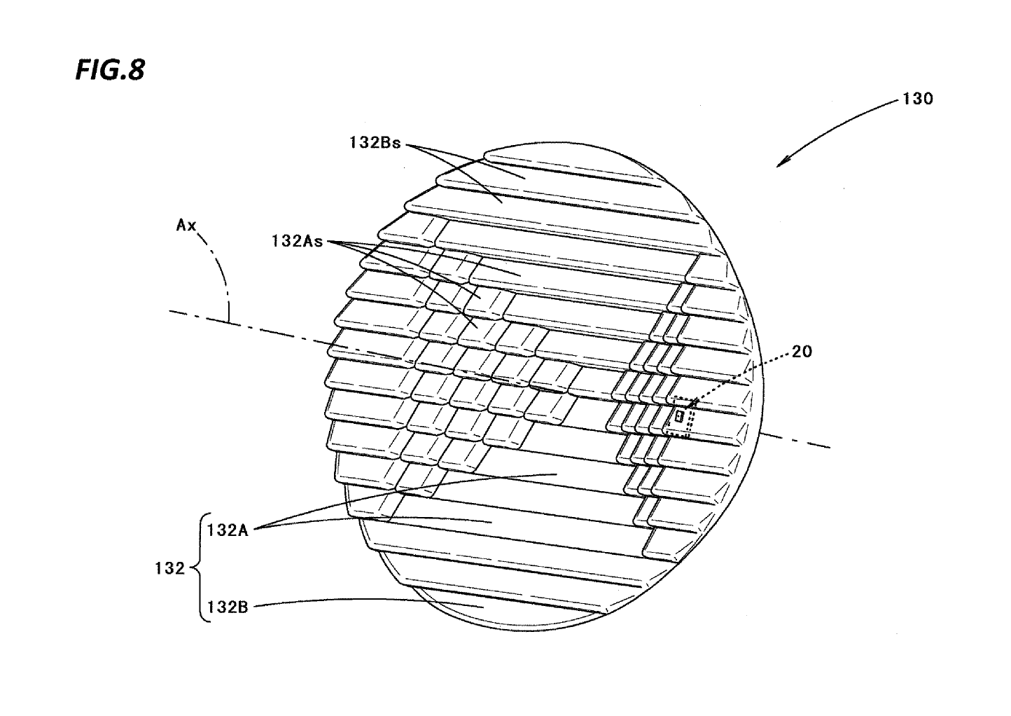

FIG. 7 is a front view illustrating the light transmitting member 130 together with the light source 20. FIG. 8 is a perspective view illustrating the light transmitting member 130 together with the light source 20.

As illustrated in FIGS. 7 and 8, in the light transmitting member 130, the light emitting surface 132 configured to emit the light, which is incident on the light transmitting member 130 from the light source 20, toward the front side has a circular external shape when viewed from the front side of the lamp.

The light emitting surface 132 is configured by five light emitting areas 132A that are divided into multiple rectangular shapes when viewed from the front side of the lamp, and the light emitting area 132B disposed at the outer periphery.

The five light emitting areas 132A are concentrically divided by square boundaries centered at the intersection point between the axis Ax and the light emitting surface 132 with an identical width when viewed from the front side of the lamp.

Further, the five light emitting areas 132A and the one light emitting area 132B are arranged to be positioned at the front side toward the outer periphery from the axis Ax.

Each of the light emitting areas 132A is divided into a plurality of light emitting elements 132As. At that time, the plurality of light emitting elements 132As are divided into horizontal stripe shapes at vertically equal intervals. Each of the light emitting elements 132As has a wedge-like vertical cross-sectional shape and is formed to extend horizontally. Accordingly, each of the light emitting elements 132As is adapted to emit the light, which reaches each of the light emitting elements 132As from the light source 20, toward the front side of the lamp while causing the light to be deflected downwardly.

Further, the light emitting area 132B is also divided into a plurality of light emitting elements 132B s. At that time, the plurality of light emitting elements 132B s are also divided into horizontal stripe shapes at vertically equal intervals. Each of the light emitting elements 132Bs has a wedge-like vertical cross-sectional shape and is formed to extend horizontally. Accordingly, each of the light emitting elements 132Bs is also adapted to emit the light, which reaches each of the light emitting elements 132Bs from the light source 20, toward the front side of the lamp while causing the light to be deflected downwardly.

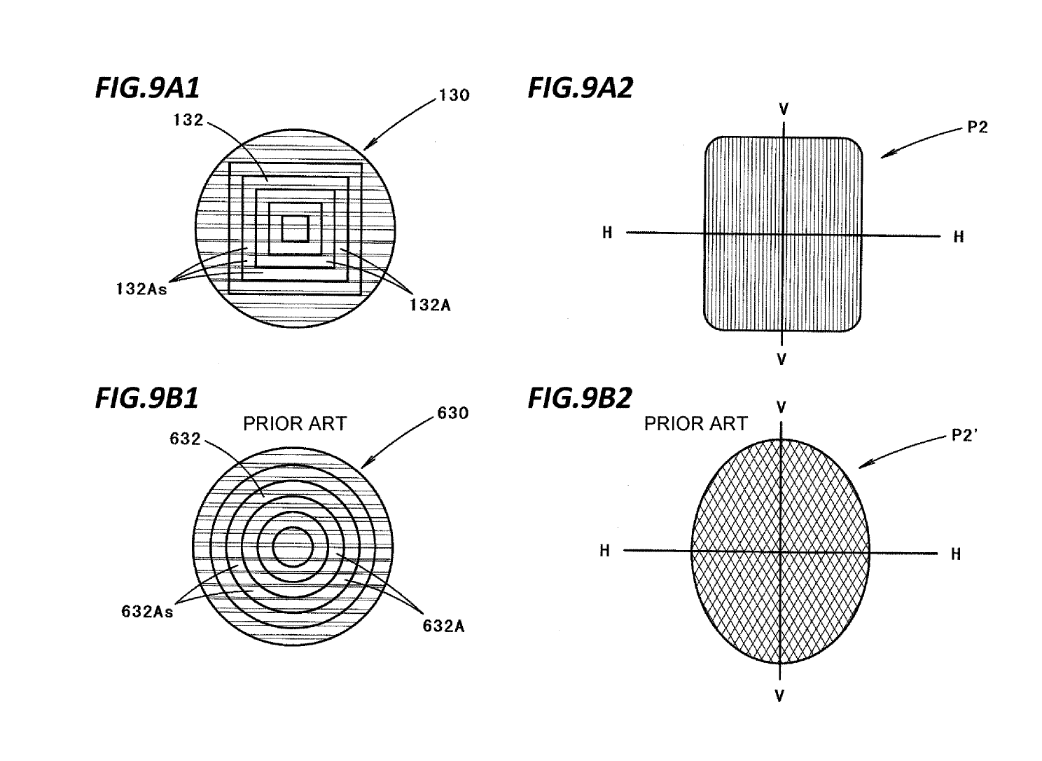

FIGS. 9A1 to 9B2 are views illustrating a comparison between the operation of the present modification and a conventional example.

FIG. 9A1 is a front view illustrating the light transmitting member 130 of the present modification. FIG. 9A2 is a view illustrating a light distribution pattern P2 formed by the light emitted from the light transmitting member 130.

Meanwhile, FIG. 9B1 is a front view illustrating the light transmitting member 630 according to a conventional example. FIG. 9B2 is a view illustrating a light distribution pattern P2′ formed by the light emitted from the light transmitting member 630.

The light transmitting member 630 is identical in its basic configuration to the light transmitting member 130 of the present modification, but is different from the present modification in that the light emitting surface 632 of the light transmitting member 630 is configured to include a plurality of light emitting areas 632A that are divided into multiple circular shapes when viewed from the front side of the lamp. Then, each of the light emitting areas 632A is divided into a plurality of light emitting elements 632As. The boundaries of the light emitting elements 632As are formed by horizontally extending straight lines and arc-shaped curves.

As illustrated in FIG. 9A2, the light distribution pattern P2 formed by the light emitted from the light transmitting member 130 has a slightly vertically long spot shape. Then, the light distribution pattern P2 is formed in a substantially rectangular external shape and has a substantially uniform light intensity distribution.

Such a light distribution pattern P2 is formed because the mutual boundaries of the respective light emitting elements 132As are formed by the vertically and horizontally extending straight lines when viewed from the front side of the lamp so that the light emitted from each of the light emitting elements 132As may be deflection-controlled with the excellent accuracy in the vertical direction.

Meanwhile, as illustrated in FIG. 9B2, the light distribution pattern P2′ formed by the light emitted from the light transmitting member 630 is also formed as a slightly vertically long light distribution pattern. However, the light distribution pattern P1′ is formed as a light distribution pattern in which each of four corners is broken and has a slightly non-uniform light intensity distribution.

Such a light distribution pattern P2′ is formed because the mutual boundaries of the respective light emitting elements 632As are partially formed by the arc-shaped curves so that the light emitted from each of the light emitting elements 632As may not be deflection-controlled with excellent accuracy in the vertical direction.

Next, the acting effects of the present modification will be described.

The light transmitting member 130 of the present modification includes the light emitting surface 132 configured to emit the light, which is incident on the light transmitting member 130 from the light source 20, toward the front side. The light emitting surface 132 includes the five light emitting areas 132A and the one light emitting area 132B that are arranged to be positioned at the front side toward the outer periphery from the center. Accordingly, even though the rear surface of the light transmitting member 130 is formed in the rotating curved surface shape, the light from the light source 20 may be emitted toward the front side without partially and extremely increasing the thickness of the light transmitting member 130.

Further, the five light emitting areas 132A are divided into multiple polygonal shapes when viewed from the front side of the lamp. Each of the light emitting areas 132A is divided into the plurality of light emitting elements 132As. Accordingly, the mutual boundaries of the respective light emitting elements 132As may be set in straight line shapes when viewed from the front side of the lamp. As a result, accuracy in deflection-controlling the light emitted from each of the light emitting elements 132As may be improved.

According to the present modification as described above, in the vehicle lamp 110 including the light source 20 and the light transmitting member 130 disposed in front of the light source 20, the light from the light source 20 may be emitted from the light transmitting member 130 toward the front side without partially and extremely increasing the thickness of the light transmitting member 130.

Especially, in the present modification, the light emitting surface 132 is divided into multiple rectangular shapes when viewed from the front side of the lamp, and the mutual boundaries of the respective light emitting elements 132As are set in vertically and horizontally extending straight line shapes when viewed from the front side of the lamp. Accordingly, even though the light transmitting member 130 is inclined in the vertical direction, it is easy to cause the light, which is emitted from each of the light emitting elements 132As and 132Bs, to be directed toward a direction close to the front direction of the lamp.

Further, in the present modification, the light transmitting member 130 also includes the first light control portion 130A configured to cause the light, which is incident on the light transmitting member 130 from the light source 20, to be emitted directly toward the front side, and the second light control portion 130B configured to cause the light, which is incident on the light transmitting member 130 from the light source 20, to be internally reflected and then emitted toward the front side. Accordingly, the light from the light source 20 may be effectively used depending on the parts of the light transmitting member 130.

In the above-described modification, it has been described that each of the light emitting elements 132As and 132Bs is configured to emit the light, which reaches the light emitting elements 132As and 132Bs from the light source 20, toward the front side of the lamp while causing the light to be deflected downwardly. However, each of the light emitting elements 132As and 132Bs may be configured to emit the light, which reaches the light emitting elements 132As and 132Bs from the light source 20, toward the front side of the lamp while causing the light to be deflected downwardly and diffused in the horizontal direction.

Meanwhile, in the above-described exemplary embodiment and modification, the numerical values indicated as specifications are merely exemplary, and of course, may be appropriately set to other values.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle lamp comprising:
a light source; and
a light transmitting member disposed in front of the light source wherein the light transmitting member includes a light emitting surface configured to emit light, which is incident on the light transmitting member from the light source, toward a front side,
the light emitting surface includes a plurality of light emitting areas that are arranged to be positioned at the front side toward an outer periphery, in a state of being divided into multiple polygonal shapes when viewed from a front side of the lamp, and
at least some of the plurality of light emitting areas are divided into a plurality of light emitting elements.

2. The vehicle lamp of claim 1, wherein the light emitting surface is divided into multiple rectangular shapes when viewed from the front side of the lamp.

3. The vehicle lamp of claim 1, wherein the light transmitting member includes a first light control portion configured to cause light, which is incident on the light transmitting member from the light source, to be emitted directly toward the front side, and a second light control portion configured to cause the light, which is incident on the light transmitting member from the light source, to be internally reflected and then be emitted toward the front side.

4. The vehicle lamp of claim 1, wherein the light transmitting member is disposed to be inclined in a vertical direction, and each of the light emitting elements is in a wedge-like shape in vertical cross section and is formed to extend horizontally.
